(19) United States
(12) Patent Application Publication
(10) Pub. No.: US 2011/0169258 A1
(43) Pub. Date: Jul. 14, 2011

(54) COUPLING ELEMENT

(75) Inventors: Karl NOWAK, Neunkirchen (DE); Iris SCHAEFER, Hanau (DE)

(73) Assignee: NORMA GERMANY GMBH, Maintal (DE)

(21) Appl. No.: 12/971,682

(22) Filed: Dec. 17, 2010

(30) Foreign Application Priority Data
Jan. 9, 2010 (DE) 102010004272.2

(51) Int. Cl. F16L 35/00; F16L 33/00; F16L 17/00

(52) U.S. Cl. 285/18; 285/240; 285/104

(57) ABSTRACT

Coupling element and method for connecting a connection line to a pipe connection of a washing machine having an external thread. The coupling element includes a first end and a nut with an internal thread arranged in the region of a first end. The nut includes an inner ring, an outer ring, and a slip clutch arranged between the inner ring and the outer ring.

### CROSS-REFERENCE TO RELATED APPLICATIONS

The present application claims priority under 35 U.S.C. §119 of German Patent Application No. 10 2010 004 272.2, filed on Jan. 9, 2010, the disclosure of which is expressly incorporated by reference herein in its entirety.

### BACKGROUND OF THE INVENTION

1. Field of the Invention

The invention relates to a coupling element for connecting a connection line to a pipe connection of a washing machine, which has an external thread. The coupling element has a nut with an internal thread in the region of a first end, which internal thread can be engaged with the external thread. Furthermore, the invention relates to a washing machine connection line with a coupling element of this type.

2. Discussion of Background Information

Coupling elements of this type are used to connect a connection line for water to a pipe connection of a washing machine, referred to below as a washing machine connection for short. The other end of the connection line is then generally connected to a water faucet. The size and geometry of washing machine connections is standardized so that the same coupling element can be used regardless of the brand of washing machine.

Conventional coupling elements are thereby constructed to have a nut on one end that can be pivoted or rotates on a flange on the end with respect to the coupling element. The nut is thereby screwed onto the washing machine connection until an axial seal arranged on the flange bears against the washing machine connection on the front face. Therefore, the flange on the end of the coupling element has the function of absorbing holding forces from the nut and the function of holding a seal on the front.

If the nut is now tightened with a large force, the seal is loaded with a high pressure between the flange and the front face of the washing machine connection, which high pressure can ultimately lead to damage to the seal. As a result, a drip-free connection of the coupling element to the washing machine connection is no longer ensured. An attempt is then often made to further tighten the nut on the washing machine connection using tools, which ultimately leads to the destruction of the seal and/or to damage to the coupling element.

When a coupling element is initially mounted on the washing machine connection it can happen that the angular position of the coupling element has to be corrected. However, Since axial forces are transmitted from the nut via the flange and the seal to the front face of the washing machine connection, a twisting of the coupling element is hardly possible, when the coupling element is mounted. In fact, this can mean that the nut is loosened or that the seal between the flange and the front face of the washing machine connection is damaged. Twisting the coupling element can thus lead, for example, to a further tightening of the nut. Further, an unintended twisting of the coupling element can also result accidentally due to the action of forces on a connection line that is connected to the coupling element.

### SUMMARY OF THE INVENTION

Accordingly, embodiments of the invention are directed to avoid overloading the coupling element.

According to embodiments of the invention, a coupling element of the type mentioned at the outset includes a nut having an inner ring and an outer ring, and a slip clutch arranged between the inner ring and the outer ring.

This slip clutch represents a torque control. The screwing of the nut is carried out manually, for example, by applying a force or a torque to the outer ring of the nut. This force is transmitted via the slip clutch to the inner ring, which is accordingly screwed onto the external thread of the pipe connection. If a defined torque is exceeded, the slip clutch slips until a reliable connection between the coupling element and the pipe connection is established, so that a further screwing of the nut onto the pipe connection and thus an increase in the axial forces is not possible. Even if a tool is used to act on the outer ring of the nut, an overload of the coupling element cannot occur. This ensures that the connection between the pipe connection and the coupling element or nut is not overloaded.

It is particularly preferred that the coupling element can be inserted with the first end into the pipe connection. This has advantages particularly in terms of flow technology, since a relatively gentle transition from the coupling element to the pipe connection can be achieved therewith. At the same time radial forces can optionally be transmitted between the coupling element and the pipe connection. In this manner, the connection of the nut and the pipe connection is unloaded. A prepositioning of the coupling element can also be achieved through the introduction of the end into the pipe connection.

Advantageously, the coupling element has a radial seal on its outer circumference in the region of the first end. Instead of using an axial seal, as has been done in the past, which is arranged between the front face of the pipe connection and a flange of the coupling element, so that the axial power flow runs through the seal, a radial seal is now provided and arranged on the outer circumference of the end inserted into the pipe connection. A reliable sealing can be achieved by this radial seal independent of a holding force. The radial seal is not loaded by the holding force.

It is particularly preferred thereby that the radial seal is accommodated in an annular groove. The annular groove is thereby arranged in the region of the first end, which can be inserted into the pipe connection. A defined position of the radial seal with respect to the coupling element is obtained through the annular groove, which defined position is also maintained during the insertion of the end into the pipe connection. Stresses on the radial seal during the insertion are thereby also kept low by the secure support of the seal in the annular groove.

Preferably, the coupling element has an annular flange in the region of the first end, so that the nut bears against a side of the annular flange that is facing away from the first end. The annular flange is thereby used to absorb axial holding forces between the nut and the coupling element. The nut is axially fixed with respect to the coupling element, but at the same time is rotatable. The nut can be held with positive engagement in a groove that is arranged on the side of the annular flange that is facing away from the end. Losing the nut is thereby virtually ruled out, even when the coupling elements are not mounted. To this end, the nut is provided on one end with a collar projecting inwards.

Advantageously, the nut has an axial mounting surface for a front face of the pipe connection. Through the screwing on of the nut, axial holding forces are thus transmitted directly from the nut via the axial mounting surface to the front face or via the thread assembly between the nut and the pipe connection. The coupling element thereby has no component in power flow. A free rotary motion of the coupling element is thereby possible even when the nut is firmly tightened. The axial mounting surface is arranged in the interior of the nut and formed, for example, by a circular axial projection that is arranged on a radial flange.

Preferably, the slip clutch has locking pawls, which are embodied or formed in one piece with the inner ring or the outer ring. The locking pawls are arranged on the outer circumference of the inner ring or on the inner circumference of the outer ring. A one-piece embodiment of this type of the locking pawls leads to a cost-effective construction of the slip clutch. The nut with the inner ring and the outer ring and the slip clutch can thereby be simply produced as an injection molded part. Fluidically sealed joints can be used due to the one-piece embodiment of the locking pawls with the corresponding ring of the nut, which further simplifies the construction of the slip clutch.

It is particularly preferred that the locking pawls are tilted to a radial direction. A preferred direction is thereby given in which the outer ring can be rotated with a relatively low torque with respect to the inner ring, while a very high torque transmission is possible in the opposite direction. As a rule a design will be carried out thereby such that the locking pawls are tilted so that a lower torque can be transmitted in the screwing-on direction than in the screwing-off direction.

Preferably, the locking pawls engage in recesses that are embodied or formed in the inner ring or in the outer ring. The recesses are embodied or formed in the ring that is not provided with the locking pawls. The recesses lead to a secure power transmission by the snapping-in of the locking pawls into the recesses. However, it is still ensured by the tilted embodiment or oblique orientation of the locking pawls that only a previously defined torque can be transmitted from the outer ring to the inner ring.

Preferably, a number of recesses exceeds a number of locking pawls. A relatively finely graduated detent of the slip clutch can thereby be achieved without an unnecessarily large number of locking pawls having to be embodied or formed. A large number of locking pawls would also mean that the slip clutch can slip through only with a relatively high torque. Since relatively low tightening forces are sufficient for a secure retention of the coupling element on the pipe connection of the washing machine, this is not desirable.

Preferably, radial projections are embodied or formed between the locking pawls. The locking pawls extend radially further than the projections. The locking pawls are elastically deformable due to their tilting in the radial direction. If radial forces are now exerted on the outer ring, this could lead to a deformation of the outer ring. A possible deformation of the outer ring is now reduced by the radial projections, in that the radial projections reduce the movement clearance between the outer ring and the inner ring. Furthermore, the radial projections serve as reinforcement.

Preferably, the inner ring has a collar projecting radially outwards, which covers the slip clutch towards the free end. The slip clutch and thus the interior of the nut are protected by this inner ring against environmental effects when the coupling element is not installed. In particular, the slip clutch is kept free from soiling.

Preferably, a connection geometry for a connection line is embodied or formed on a second end of the coupling element. The second end is embodied or formed in particular as a plug-in part. The coupling element can be connected relatively easily to a connection line. If necessary, an additional hose clamp can also be provided thereby, which prevents a detachment of the connection line from the coupling element. In any case a secure connection between the coupling element and the connection line is ensured by means of the connection geometry.

Further, embodiments of the invention are directed to a washing machine line with the above-described coupling element. A connection line is connected to the second end of the coupling element.

Embodiments of the invention are directed to a coupling element for connecting a connection line to a pipe connection of a washing machine having an external thread. The coupling element includes a first end and a nut with an internal thread arranged in the region of a first end. The nut includes an inner ring, an outer ring, and a slip clutch arranged between the inner ring and the outer ring.

According to embodiments, the internal thread can be engageable with the external thread,

In accordance with other embodiments, the first end may be structured and arranged for insertion into the pipe connection.

In accordance with other aspects, the coupling element may include a radial seal arranged around a circumference in the region of the first end.

According to further features of the embodiments, an annular flange can be located in the region of the first end. The nut may bear against a side of the annular flange facing away from the first end.

In accordance with still other embodiments of the invention, the nut can further include an axial mounting surface for a front face of the pipe connection.

According to further embodiments of the instant invention, the slip clutch can have locking pawls that are structured and arranged in one piece with one of the inner ring or the outer ring. The locking pawls can be arranged on one of an outer circumference of the inner ring or on an inner circumference of the outer ring. The locking pawls may be obliquely oriented to a radial direction. The coupling element may also include recesses formed in one of the inner ring and outer ring, and the locking pawls can be structured and arranged to engage in the recesses. A number of recesses is greater than a number of locking pawls. The coupling element may also include radial projections formed between the locking pawls, so that the locking pawls extend radially further than the projections.

In accordance with still other embodiments, the inner ring can have a collar projecting radially outwards that covers the slip clutch towards a free end.

According to other aspects, the coupling element may also include a second end. A connection geometry for a connection line can be formed on the second end, and the second end may be formed as a plug-in part.

Embodiments of the invention are directed to a washing machine connection line having a coupling element, as described above, that further includes a second end pushed into the connection line.

Embodiments of the invention are directed to a method for connecting a connection line to a pipe connection of a washing machine having an external thread. The method includes connecting a first end of a coupling element to the pipe connection via a nut having an internal thread to engage the external thread and having an inner and an outer ring and rotating outer ring relative to the inner ring to tighten the nut on the pipe connection to a predetermined torque. Upon achieving the predetermined torque, a slip clutch arranged between the inner and outer rings prevents further tightening of the nut on the pipe connection.

According to embodiments, the method may also include plugging the connection line onto a second end of the coupling device.

In accordance with still yet other embodiments of the present invention, when the nut is connected on the pipe connection with the predetermined torque, the coupling element can be pivotable around the pipe connection without affecting a connection force between the nut and the pipe connection.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a coupling element in a three-dimensional view;

FIG. 2 illustrates a coupling element in sectional side view;

FIG. 3 illustrates the coupling element according to FIG. 2 in a sectional plan view;

FIG. 4 illustrates a coupling element in a sectional side view;

FIG. 5 illustrates the coupling element according to FIG. 4 in a sectional plan view; and

FIG. 6 illustrates a coupling element in a three-dimensional view.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

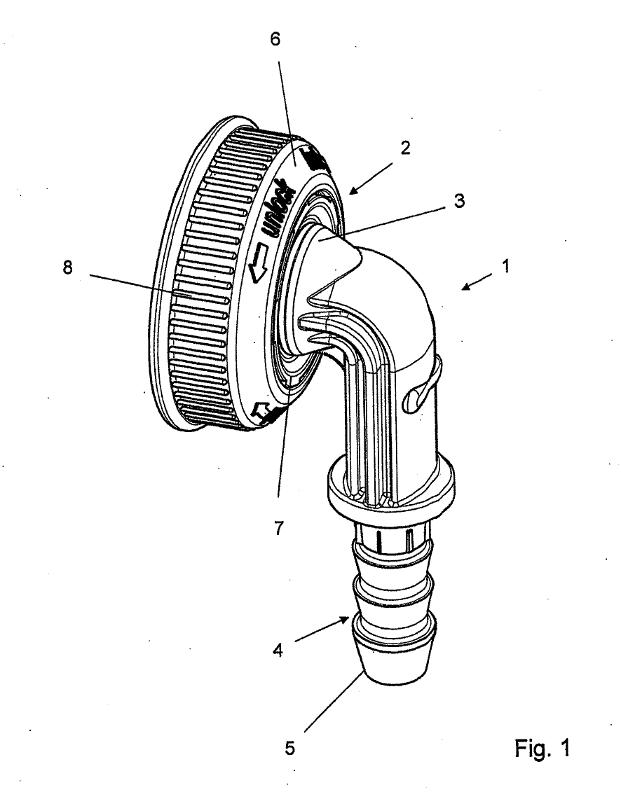

FIG. 1 shows a coupling element 1 with a nut 2, which is arranged in the region of a first end 3 of the coupling element 1. Coupling element 1 and nut 2 form a coupling arrangement. A second end 4 is provided with a connection geometry 5 for connecting the coupling element 1 to a connection line. Between the first end 3 and the second end 4 the coupling element is angled by 90°.

The nut 2 has an outer ring 6 and an inner ring 7. A slip clutch 15 (not visible in FIG. 1, but see, FIGS. 3 and 5) arranged between the outer ring 6 and the inner ring 7.

On its outer circumference, outer ring 6 has recesses 8, which are used for better torque transmission to outer ring 6. Outer ring 6 is thereby provided with an identification in the form of arrows and writing that gives a direction of rotation for screwing on (locking) nut 2 and for unscrewing (unlocking) nut 2.

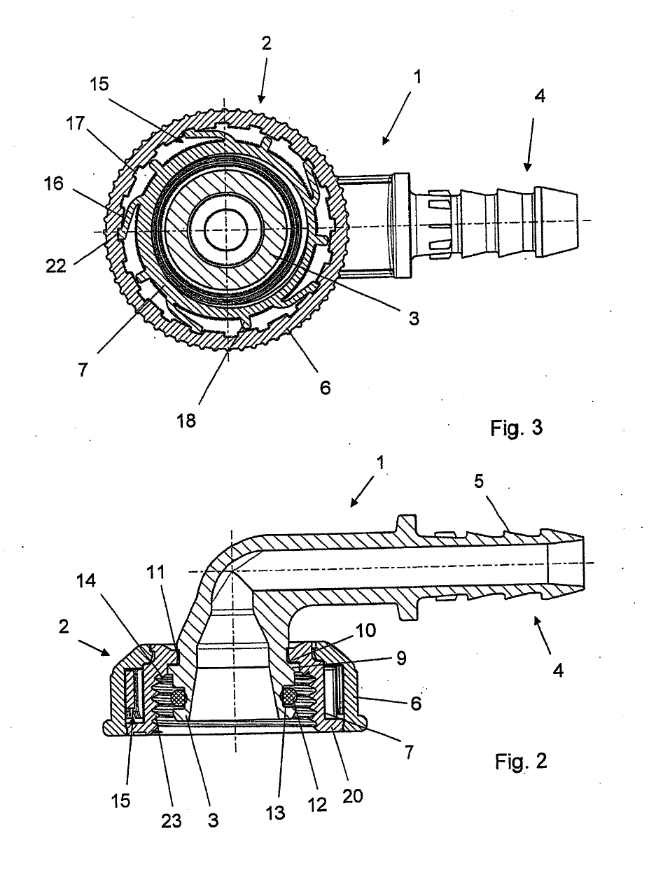

FIG. 2 shows a sectional representation of coupling element 1. Coupling element 1 has an annular flange 9 in a region of first end 3, so that a collar 10 of nut 2 bears against a side of annular flange 9 facing away from end 3 of the coupling element 1. Accordingly, collar 10 of nut 2 is thereby held axially in a groove 11 in coupling element 1. In this manner, nut 2 is held positively in groove 11 so that a rotary movement between coupling element 1 and nut 2 is possible. End 3 is embodied or formed such that it can be inserted into a pipe connection of a washing machine. Nut 2 then overlaps the pipe connection so that it can be screwed onto an external thread of the pipe connection with its internal thread 23. A radial seal 12, positionable on or near end 3, can be accommodated in an annular groove 13 arranged on or near end 3. A radial sealing between the pipe connection of a washing machine and coupling element 1 is achieved by radial seal 12.

Nut 2 has on its inner ring 7 an axial mounting surface 14 for a front face of the pipe connection. When the nut is completely screwed on, mounting surface 14 bears against the front face of the pipe connection so that a direct force transmission from the nut to the pipe connection takes place. Coupling element 1 itself remains freely rotatable since no axial forces are transmitted via coupling element 1. Flange 9 serves only to hold coupling element 1 axially inside nut 2 and not to transmit forces from nut 2 to the pipe connection.

In FIG. 3, coupling element 1 according to FIG. 2 is shown in a sectional view. Slip clutch 15 is arranged between outer ring 6 and inner ring 7 of nut 2. Slip clutch 15 has locking pawls 16 and recesses 17. Locking pawls 16 are tilted with respect to a radial direction and feet 22 are embodied or formed at ends of locking pawls 16 to engage in recesses 17. A secure transmission of force between recesses 17 and feet 22 or locking pawls 16 is thereby possible. Radial projections 18 are embodied or formed between locking pawls 16, but do not radially project as far as locking pawls 16.

Due to the tilted embodiment (or angular orientation) of locking pawls 16, a higher torque can be transmitted in one direction of rotation than in the opposite direction. According to the representation in FIG. 3, with a rotation of outer ring 6 in a clockwise direction, a very high torque can be transmitted to inner ring 7, while with a rotation of outer ring 6 in an opposite counterclockwise direction, when a defined torque is exceeded, locking pawls 16 slip out of the recesses 17 so that no further force transmission is possible between outer ring 6 and inner ring 7. A threading force with which nut 2 can be screwed onto the pipe connection of the washing machine is thereby limited.

In the embodiment according to FIG. 3, the elastic locking pawls 16 are embodied or formed in one piece with inner ring 7 and recesses 17 are shaped in outer ring 6. Projections 18 are likewise embodied or formed in one piece with inner ring 7.

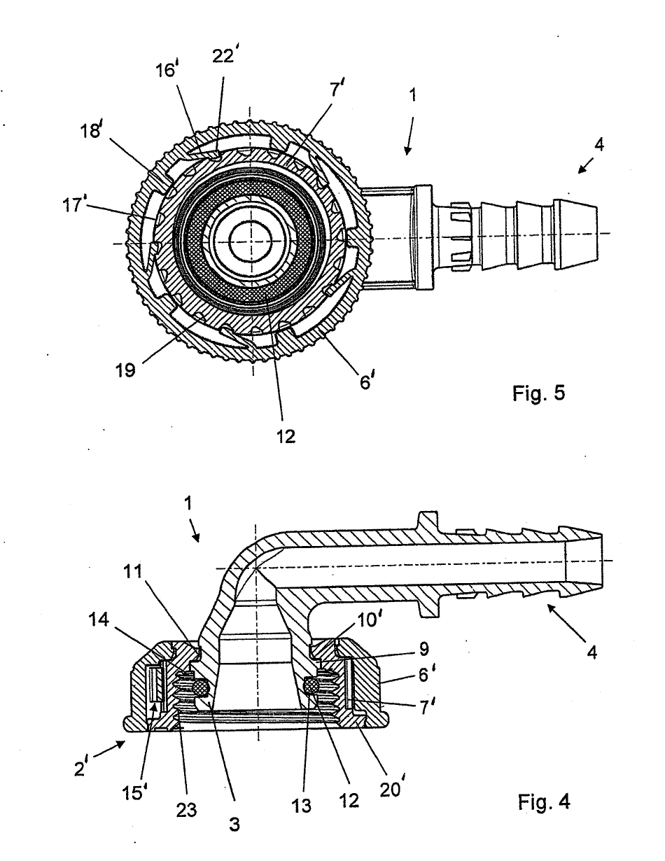

FIG. 4 shows a coupling element 1 with a nut 2′, which essentially corresponds to the embodiment according to FIG. 2, except that slip clutch 15′, which can be seen from FIG. 5, is structured and arranged differently from slip clutch 15. In this embodiment, locking pawls 16′ are embodied or formed in one piece with outer ring 6′, while recesses 17′ are shaped in inner ring 7′. Recesses 17′ thereby have a tilted base 19, which is tilted in a same direction as locking pawls 16′. It is thereby more easily possible for locking pawls 16′ to slip out of recesses 17 in one direction.

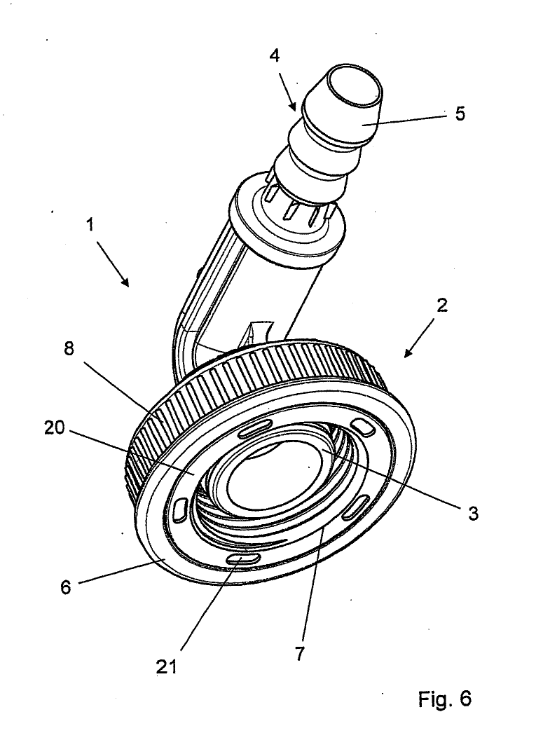

FIG. 6 shows coupling element 1 with nut 2 in a three-dimensional representation from a side that faces towards the washing machine when coupling element 1 is mounted. A collar 20 of inner ring 7 is discernible, which covers slip clutch 15 to the outside. Collar 20 thereby prevents a soiling of slip clutch 15. Shapings 21 are embodied or formed thereby in collar 20, into which it is possible to engage with a suitable tool if inner ring 7 is to be held with respect to outer ring 6.

Through the embodiments of the coupling element according to the invention, a coupling element is obtained which is held with a defined force with respect to a pipe connection of a washing machine. A free rotation of the coupling element is maintained. At the same time, a secure seal is achieved through the use of a radial seal, so that there is no risk of damage to the seal or detachment of the pipe connection of the washing machine even by a rotary movement of the coupling element after assembly. At the same time, the coupling element according to embodiments of the invention with the associated nut can be produced cost-effectively as an injection molded part. The assembly of the coupling element is carried out in the conventional manner, that is, as with the coupling elements hitherto used.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A coupling element for connecting a connection line to a pipe connection of a washing machine having an external thread, comprising:
a first end; and
a nut with an internal thread arranged in the region of a first end,
wherein the nut includes an inner ring, an outer ring, and a slip clutch arranged between the inner ring and the outer ring.

2. The coupling element in accordance with claim 1, wherein the internal thread is engageable with the external thread,

3. The coupling element in accordance with claim 1, wherein the first end is structured and arranged for insertion into the pipe connection.

4. The coupling element in accordance with claim 1, further comprising a radial seal arranged around a circumference in the region of the first end.

5. The coupling element in accordance with claim 1, further comprising an annular flange located in the region of the first end.

6. The coupling element in accordance with claim 5, wherein the nut bears against a side of the annular flange facing away from the first end.

7. The coupling element in accordance with claim 1, wherein the nut further includes an axial mounting surface for a front face of the pipe connection.

8. The coupling element in accordance with claim 1, wherein the slip clutch has locking pawls that are structured and arranged in one piece with one of the inner ring or the outer ring.

9. The coupling element in accordance with claim 8, wherein the locking pawls are arranged on one of an outer circumference of the inner ring or on an inner circumference of the outer ring.

10. The coupling element in accordance with claim 8, wherein the locking pawls are obliquely oriented to a radial direction.

11. The coupling element in accordance with claim 8, further comprising recesses formed in one of the inner ring and outer ring, wherein the locking pawls are structured and arranged to engage in the recesses.

12. The coupling element in accordance with claim 11, wherein a number of recesses is greater than a number of locking pawls.

13. The coupling element in accordance with claim 8, further comprising radial projections formed between the locking pawls, wherein the locking pawls extend radially further than the projections.

14. The coupling element in accordance with claim 1, wherein the inner ring has a collar projecting radially outwards that covers the slip clutch towards a free end.

15. The coupling element in accordance with claim 1, further comprising a second end, wherein a connection geometry for a connection line is formed on the second end, and wherein the second end is formed as a plug-in part.

16. A washing machine connection line having a coupling element in accordance with claim 1, that further includes a second end pushed into the connection line.

17. A method for connecting a connection line to a pipe connection of a washing machine having an external thread, comprising:
connecting a first end of a coupling element to the pipe connection via a nut having an internal thread to engage the external thread and having an inner and an outer ring; and
rotating outer ring relative to the inner ring to tighten the nut on the pipe connection to a predetermined torque,
wherein, upon achieving the predetermined torque, a slip clutch arranged between the inner and outer rings prevents further tightening of the nut on the pipe connection.

18. The method in accordance with claim 17, further comprising plugging the connection line onto a second end of the coupling device.

19. The method in accordance with claim 17, wherein, when the nut is connected on the pipe connection with the predetermined torque, the coupling element is pivotable around the pipe connection without affecting a connection force between the nut and the pipe connection.
